(19) United States
(12) Patent Application Publication
(10) Pub. No.: US 2011/0282918 A1
(43) Pub. Date: Nov. 17, 2011

(54) POPULATION ANALYSIS COMBINING INTERACTIVITY, ORTHOGONAL LINEAR DISPLAYS AND GEOSPATIAL DISPLAYS

(76) Inventor: David P. Fan, St. Paul, MN (US)

(21) Appl. No.: 13/077,288

(22) Filed: Mar. 31, 2011

Related U.S. Application Data
(60) Provisional application No. 61/395,384, filed on May 12, 2010.
(60) Provisional application No. 61/404,747, filed on Oct. 11, 2010.

(51) Int. Cl. G06F 17/30; G06F 7/08

(52) U.S. Cl. 707/804; 707/E17.044; 707/E17.018

(57) ABSTRACT

A method to analyze a population may include accessing data representing a population of individuals, wherein each individual in the population is associated with a plurality of properties having values; constructing and displaying a property stack including: at least one property row, wherein each property row includes a series of value bars corresponding to one of the plurality of properties and wherein a value bar represents a value of the property associated with an individual in the population; and wherein a value column includes a plurality of value bars associated with an individual and wherein the value bars are aligned in a column; sorting the series of value bars within the at least one property row; receiving user input specification for a manipulation of a portion of the property stack; and in response to the user input, updating the property stack.

### RELATED APPLICATIONS

The present application claims priority to U.S. Provisional Application 61/395,384, which was filed on May 12, 2010, and U.S. Provisional Application 61/404,747 which was filed on Oct. 11, 2010, both of which are incorporated herein by reference.

### FIELD OF THE INVENTION

The technical field relates generally to the field of data analysis more specifically, systems, methods, displays, and structures for analyzing populations of individuals wherein each individual possesses values for a set of properties.

### BACKGROUND

In various situations a may wish to search for a physical property and have it displayed on a map. For example, a user may use a computer and search for hotels within a given geographic location and for a given price range. A map may then be displayed with the hotels matching the user criteria.

### COPYRIGHT NOTICE

A portion of the disclosure of this invention contains material which is subject to copyright protection. The copyright owner has no objection to the facsimile reproduction by anyone of the invention or the patent disclosure as it appears in the Patent and Trademark Office patent files or records, but otherwise reserves all copyright rights whatsoever. The following notice applies to the software and data as described below and in the drawings attached hereto: Copyright© 2011, David P. Fan, All Rights Reserved.

### SUMMARY

Consider, in an embodiment, a population consisting of individuals with each individual having values for a set of properties with at least one property being associated with a set of geospatial coordinates and at least one other property. One method for analyzing information about the individuals is to display the geospatial coordinates on a geospatial map and values for other properties of the individuals in the form of text. However, text for displays has a disadvantage in requiring large amounts of space.

Systems, methods, and structures to support enhanced population analysis are disclosed. In an embodiment, a population includes individuals with each individual having values for a set of properties with at least one property represented as geospatial coordinates. The system includes individuals, communication means that allows access to values of properties of individuals, and a population analysis engine for constructing a composite display including a geospatial map indicating geolocations of the individuals linked to another graphical representation for values of properties of individuals wherein the values and individuals are displayed in orthogonal directions. The display may allow a user to change the display interactively using an input device (e.g., pointing device).

### BRIEF DESCRIPTION OF THE DRAWINGS

FIG. 1 is a block diagram of a system according to one aspect of the invention discussed herein.

FIG. 2 is a structure diagram of a structure according to one aspect of the invention discussed herein.

FIG. 3 is a process diagram of a method according to one aspect of the invention discussed herein.

FIG. 4 is a process diagram of an example method according to one aspect of the invention discussed herein.

FIG. 5 is a display diagram of an example display according to one aspect of the invention discussed herein.

FIG. 6 is a process diagram of a method according to one aspect of the invention discussed herein.

FIG. 7 is a display diagram of an example display according to one aspect of the invention discussed herein.

FIG. 8 is a display diagram of an example display according to one aspect of the invention discussed herein.

FIG. 9 is a display diagram of an example display according to one aspect of the invention discussed herein.

FIG. 10 is a process diagram of a method according to one aspect of the invention discussed herein.

FIG. 11 is a process diagram of an example method according to one aspect of the invention discussed herein.

FIG. 12 is a display diagram of an example display according to one aspect of the invention discussed herein.

FIG. 13 is a process diagram of a method according to one aspect of the invention discussed herein.

FIG. 14 is a display diagram of an example display according to one aspect of the invention discussed herein.

FIG. 15 is a display diagram of an example display according to one aspect of the invention discussed herein.

### DETAILED DESCRIPTION

In the following detailed description of exemplary embodiments of the invention, reference is made to the accompanying drawings which form a part hereof, and in which is shown, by way of illustration, specific exemplary embodiments in which the invention may be practiced. In the drawings, like numerals describe substantially similar components throughout the several views. These embodiments are described in sufficient detail to enable those skilled in the art to practice the invention. Other embodiments may be utilized and structural, logical, electrical, and other changes may be made without departing from the spirit or scope of the invention discussed herein. The following detailed description is, therefore, not to be taken in a limiting sense, and the scope of the invention discussed herein is defined only by the appended claims.

Various embodiments of the invention discussed herein focus on a system for interactive population analysis wherein a population includes a plurality of individuals. The system includes at least one property of an individual. In an embodiment, the property includes a name, a value, and a condition for specifying the value. In an embodiment, a property includes a geolocation wherein the geolocation value is the set of coordinates (e.g., longitude, latitude, altitude) specifying the geolocation on a geospatial map. Within this disclosure, a physical property is distinguishable from a property of an individual. In various embodiments, a property of an individual refers to a characteristic of the individual (e.g., location, size, content, type, price, etc.) whereas a physical property is associated with a real object (e.g., a hotel).

In various embodiments an individual may represent various entities. For example in various embodiments, an individual is the owner of the value of a property. In an embodiment, an individual is a person. In an embodiment, an individual is a commercial product. A commercial product may be a product offered for sale through e-commerce. In an embodiment, a commercial product is a product offered for sale through an Internet website. In an embodiment, a commercial product is a hotel. In an embodiment, an individual is a document. In an embodiment, a document includes a combination of text and graphics (e.g., all text, all graphics, or a mix). In another embodiment, an individual is a portion of a document. In an embodiment, an individual includes a representation of an individual and not an individual itself. In an embodiment, a property is a representation of a property and not the property itself. In various embodiments, the system of population analysis focuses on a method for presenting individuals and values of the properties of the individuals in a form that is both compact and clear.

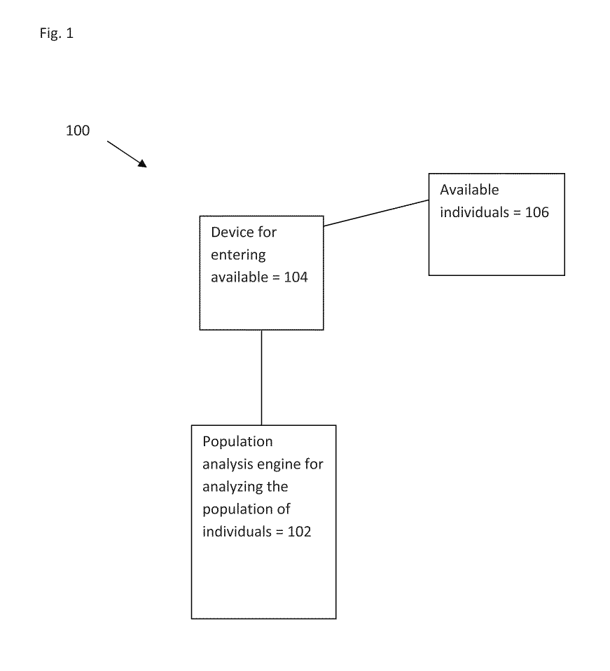

FIG. 1 is a block diagram of a system according to one aspect of the invention discussed herein. In an embodiment, a system 100 includes a population analysis engine 102. In an embodiment, the population analysis engine 102 includes software for displaying a representation of a population.

In an embodiment, the population analysis engine 102 is adapted to interface with a device 104 for entering available individuals 106. In various embodiments, device 104 includes a keyboard, a pointing device, a connection to a remote data source, software operating on the device 104 for entering properties and for extracting values of properties of individuals for input into the population analysis engine 102.

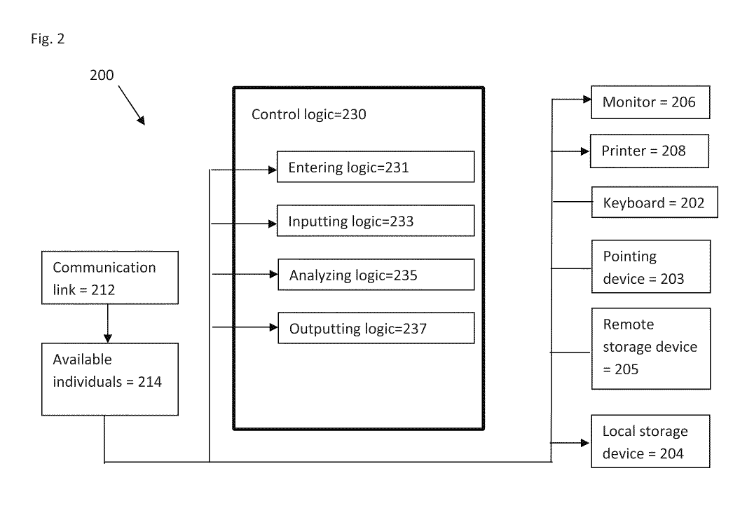

FIG. 2 is a block diagram of a system 200 according to an embodiment of the invention. In an embodiment, system 200 is designed to use available individuals 214 for constructing a population. In an embodiment, data representing individuals 214 are accessed through communication link 212 to access a remote storage device 205, local storage device 204, a keyboard 202, a printer 208, a monitor 206, and a pointing device 203. In an embodiment, the system 200 includes a controller 230 that includes control logic to control a population analysis process. In an embodiment, control logic 230 includes one or more logics including entering logic 231 for controlling the task of entering data representing individuals and properties from remote storage device 205 into a local storage device 204, inputting logic 233 for controlling the task of inputting user specified conditions for population analysis, analyzing logic 235 for controlling the population analysis, and outputting logic 237 for controlling the output of the population analysis. While FIG. 2 illustrates a series of separate logics 231, 233, 235, and 237 within control logic 230, in various embodiments some of the logics may be omitted or combined. For example, there may be a single logic that controls the tasks of entering, inputting, and analyzing. In various embodiments, the logics may be implemented as modules.

In an exemplary embodiment provided for illustrative purposes, the system 100 is instantiated by creating an instance called “example 1” wherein an individual is a hotel.

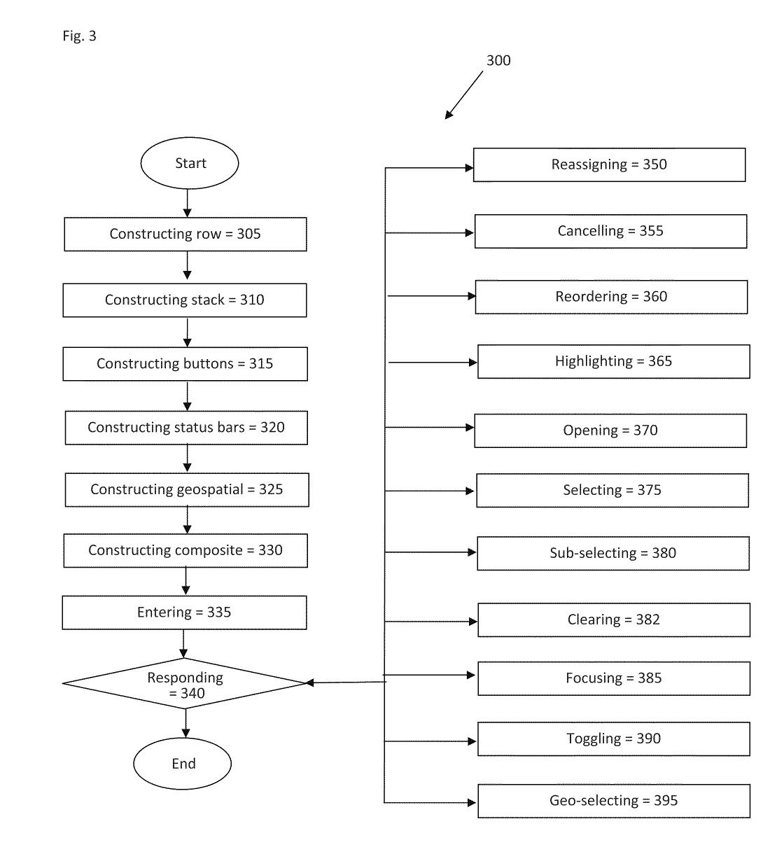

FIG. 3 is a process diagram of a process 300 according to an embodiment of example 1 of the invention for population analysis.

In an embodiment, the process 300 includes an act constructing row 305 for constructing a horizontal property row. In an embodiment, the process 300 includes an act constructing stack 310 for constructing a property stack wherein the property stack is a vertical stack of property rows including at least one property row. The act 310 orders the rows in a specified original row order. For example, the top property row in the property stack may be given first priority in the sorting.

In an embodiment, the process 300 includes an act constructing buttons 315 for constructing an upper button and a lower button for accepting user input. In an embodiment, the process 300 includes an act constructing status bars 320 for constructing an upper status bar and a lower status bar for displaying information to a user.

In an embodiment, the process 300 includes an act constructing geospatial 325 for constructing a geospatial map.

In an embodiment, the process 300 includes an act constructing composite 330 for constructing a composite display including a property stack, an interactive button, a status bar, and a geospatial map.

In an embodiment, the process 300 includes an act entering 335. The act 335 enters the value of a property of an owner into a composite display. In an embodiment, the act 335 enters the geolocation value of an owner as a marker on the geospatial map of the composite display. In an embodiment, the act 335 enters the property value of an owner as a vertical value bar in a property row wherein the owner of the property value is the owner of the value bar.

In an embodiment, the process 300 includes an act responding 340 for responding to a user command. In various embodiments user commands are user inputs specifications which specify actions such as reassigning, reordering, cancelling, highlighting, opening, selecting, sub-selecting, clearing, focusing, toggling, and geo-selecting portions of a composite display. In various embodiments, the user input is entered using a pointer device, voice control, touch control, or gesture control. Act 340 may respond by updating the property stack or another part of the composite display.

In an embodiment, the process 300 includes an act reassigning 350 for reassigning a height of a value bar according to at least one user specification. In an embodiment, the process 300 includes an act cancelling 355 for cancelling the reassigning of the height of a value bar. In an embodiment, the process 300 includes an act reordering 360 for reordering the sequence of property rows in a property stack. In an embodiment, the process 300 includes an act highlighting 365 for highlighting the value of each property of the same owner in response to a user hovering a pointing device over a property value. In an embodiment, the process 300 includes an act opening 370 for opening a display of extended properties for the owner of a property value. In an embodiment, the process 300 includes an act selecting 375 for selecting at least one owner wherein the owner is a selected owner. In an embodiment, the process 300 includes an act sub-selecting 380 for sub-selecting at least one owner wherein the owner is a sub-selected owner. In an embodiment, the process 300 includes an act clearing 382 for deselecting a selected owner, for deselecting a sub-selected owner, and for resetting the row order in a property stack to the specified original row order.

In an embodiment, the process 300 includes an act focusing 385 for focusing a geospatial map according to at least one user specification. In an embodiment, the process 300 includes an act toggling 390 for toggling a geospatial map between a geo-exploring mode and a geo-selecting mode. In an embodiment, the process 300 includes an act geo-selecting 395 for selecting the owner of a geolocation value wherein the owner of the value is a selected owner.

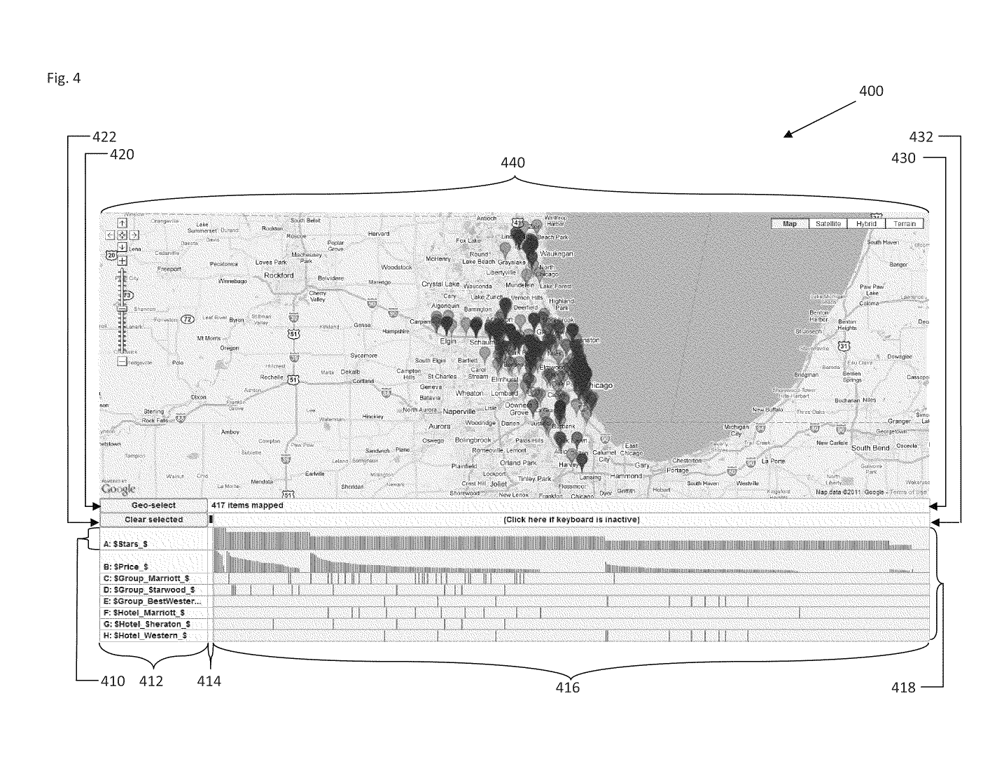

FIGS. 4-15 include exemplary uses of the system for analyzing a population of hotels. As such, the prefixes, text formats, shading, colors, properties, text strings, and button layouts used in FIGS. 4-15 are intended to be exemplary in nature and may be changed in various embodiments.

FIG. 4 is a display diagram of a display 400 according to an instance of example 1 of the invention discussed herein. Display 400 is an exemplary image of a composite display on the monitor according to a process 300. The display may be outputted to a display device of a user of the system.

For display 400, the act 305 assigns a property name to include a prefix letter in the form of a letter of the alphabet, a following colon symbol, and a following abbreviated name. In an embodiment, the act 305 assigns no two properties to include the same prefix letter. For display 400, an act 305 displays an exemplary property row 410. In an embodiment, a property row includes a name rectangle 412, a reassigning rectangle 414, and a values rectangle 416. In an embodiment, the act 305 assigns a name rectangle to include a property name. In an embodiment, no two property rows include the same property.

In property row 410, the act 305 assigns the property name “A: $Stars_$” to include the prefix letter “A” followed by the colon symbol followed by the abbreviated name “$Stars_$.”

In an embodiment, a property row is referenced by the prefix letter of the property row. Accordingly, property row 410 is referenced as row A.

In an embodiment, a property is referenced by the prefix letter of the property name. Accordingly, property A refers to the property of row A

For display 400, an act 310 displays a property stack 418 with 8 property rows in the specified original order from top to bottom:

Row A represents the star rating of a hotel ranging from the high value of 5 down to 1 in increments 1 with the value 0 representing no available star rating.

Row B represents the price of a hotel room in dollars with the value 0 representing no available price.

Row C represents the membership of a hotel in the Marriott group of hotels with the value 1 representing membership and the value 0 representing non-membership.

Row D represents the membership of a hotel in the Starwood group of hotels with the value 1 representing membership and the value 0 representing non-membership.

Row E represents membership of a hotel in the Best Western group of hotels with the value 1 representing membership and the value 0 representing non-membership.

Row F represents a hotel description including the text string “Marriott” with the value 1 representing inclusion and the value 0 representing exclusion.

Row G represents a hotel description including the text string “Sheraton” with the value 1 representing inclusion and the value 0 representing exclusion.

Row H represents a hotel description including the text string “Western” with the value 1 representing inclusion and the value 0 representing exclusion.

In an embodiment, the act 305 assigns all rectangles in a property row to the same height. In an embodiment, the act 305 assigns like rectangles in all property rows to the same width.

For display 400, an act 315 displays an upper interactive button 420 and a lower interactive button 422.

For display 400, an act 320 displays an upper status bar 430 and a lower status bar 432.

For display 400, an act 325 displays a geospatial map 440.

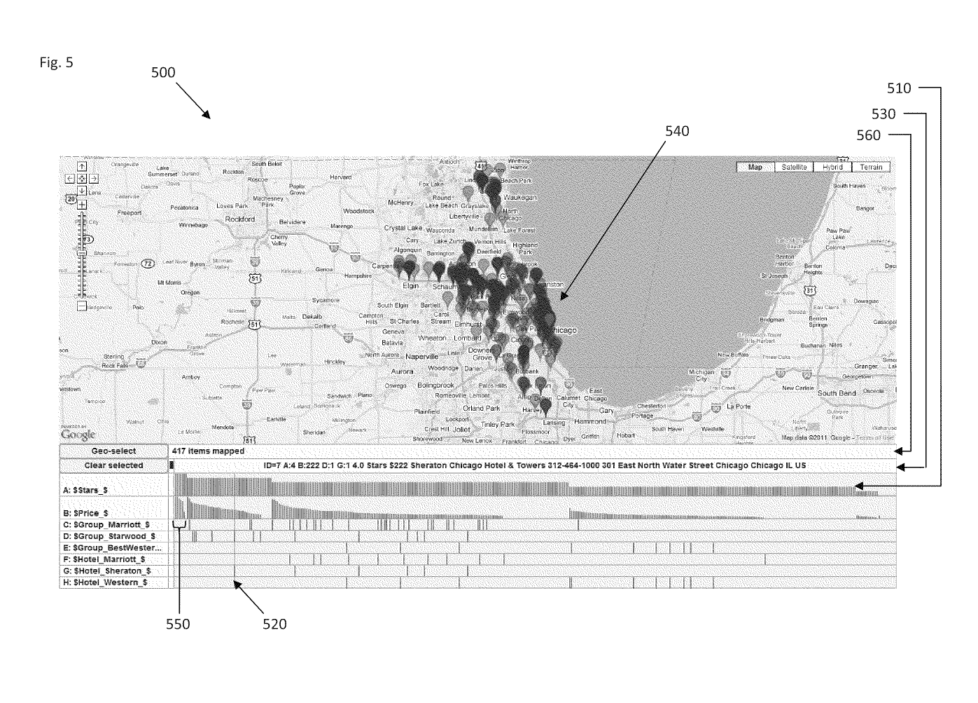

FIG. 5 is a display diagram of a composite display 500 derived from display 400.

For display 500, an act 335 modifies display 400 by entering a property value of an owner. The act 335 enters a property value as a vertical value bar in the values rectangle of the property row. The act 335 uses the blue color to display the portion of the value bar above a minimal specified value and below a maximum specified value.

For the exemplary value bar 510, the act 335 displays an exemplary blue bar in row A with a height corresponding to a 2 star hotel. For row A, the minimal specified value is 0 stars and the maximum specified value is 5 stars. Accordingly, the exemplary value bar spans the lower two-fifths of the vertical height of the values rectangle of row A.

For display 500, an act 335 displays value bars for all owners in all property rows wherein all vertical value bars for the same owner are placed at the same horizontal position in all property rows. Accordingly, all value bars for the same owner are displayed in a single vertical values column at the same horizontal position.

In an embodiment, an act 365 assigns an owner as a highlighted owner during the time that a user hovers a pointer over the values column of the owner.

For display 500, an act 365 uses the blue color to display a geolocation marker for the geolocation value of an owner on the geospatial map.

In an embodiment, an act 365 assigns an owner as a highlighted owner during the time that a user hovers a pointer over the geolocation marker of the owner.

In an embodiment, an act 365 uses a red color to display a highlighted values column wherein the highlighted values column is the values column of a highlighted owner during the time that an owner is a highlighted owner. In an embodiment, the act 365 uses a red color to display a highlighted geolocation marker wherein the highlighted marker is the geolocation maker of the highlighted owner during the time that the owner is a highlighted owner. In an embodiment, the act 365 uses the lower status bar to display a property summary for the highlighted owner during the time that the owner is a highlighted owner.

For an exemplary highlighted owner, an act 365 uses the red color to display the highlighted values column 520 of the owner wherein the blue bars of the column indicate that the highlighted owner is a hotel with property values of: star rating of 4 stars from row A, hotel room price of $222 from row B, membership in the Starwood group from row D, and inclusion of the text string “Sheraton” in the hotel description from row G. The act 365 uses the red color to display the exemplary highlighted geolocation marker 540 for the highlighted owner. The act 365 displays the exemplary property summary 530 for the highlighted owner wherein the property summary includes the text “ID=7 A:4 B:222 D:1 G:1 4.0 Stars $222 Sheraton Chicago Hotel & Towers 312-464-1000 East North Water Tower Street Chicago Ill. US.” A portion of the summary includes the text “A:4 B:222 D:1 G:1” including the prefix letters “A,” “B,” “D,” and “G” each followed by a colon symbol followed by the value of the property.

In an embodiment for display 500, the act 335 performs a two-key column sort wherein the column sort is a two-key hierarchical sort of all values columns in a property stack. The first key of the sort is decreasing heights for value bars in a property row from left to right.

In the exemplary stack for display 500, the act 335 uses the first key to sort values columns according to value bars decreasing in height monotonically from left to right in the top row A.

The second key of the sort is the sequence of rows in the property stack from top to bottom. In the exemplary region 550, the act 335 finds the same heights for all value bars in the top row wherein the top row is row A. Accordingly, for values columns in region 550, the act 335 uses the second key to sort all values columns according to decreasing heights in the second row wherein the second row is row B.

The act 335 displays the sorted values columns in the composite display.

In an embodiment for display 500, an act 335 displays statistics about owners in the upper status bar. In exemplary status bar 560, the statistics include the information that property values are displayed for the total of 417 owners.

In an embodiment for display 500, an act opening 370 opens a separate display with detailed information about a highlighted owner. In an embodiment, the act 370 opens an internet webpage with detailed information about the highlighted owner after a user clicks a pointing device over the highlighted marker 540. In an embodiment, the act 370 opens an internet webpage with detailed information about the highlighted owner after a user clicks a pointing device over the highlighted values column 520.

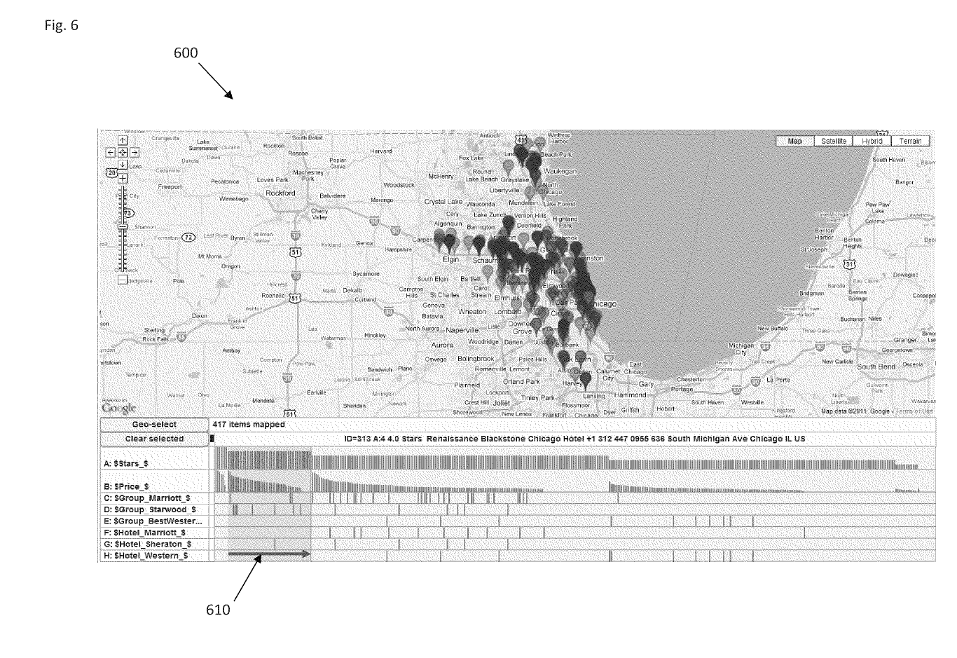

FIG. 6 is a display diagram of a composite display 600 derived from display 500.

For display 600, a user modifies display 500 by placing a pointer down at the tail of the red arrow 610 and dragging the pointer to the right in the direction of the head of the red arrow. An act 375 responds by using a darkened color to display values columns extending horizontally from the pointer down position to the pointer position during the dragging.

The user performs a pointer up action at the head of the red arrow 610. The act 375 uses a darkened color to display the region of values columns between the pointer down and pointer up positions as a selected column region wherein all values columns in the selected column region are assigned as selected columns and all owners of selected columns are assigned as selected owners.

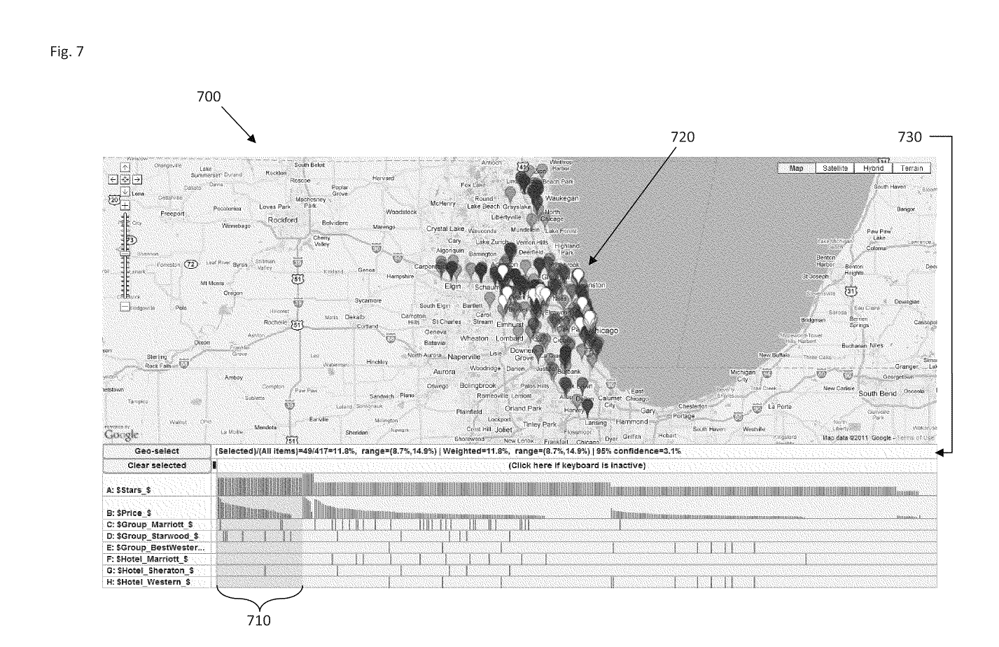

FIG. 7 is a display diagram of a composite display 700 derived from display 600 subsequent to the pointer up action of display 600.

The act 375 responds to the pointer up action by performing a three-key column sort for values columns wherein the sort is a hierarchical sort with the first key being assignment as a selected column. The second and third keys of the three-key column sort are the first and second keys used for a two-key column sort.

For display 700, the act 375 performs a three-key column sort for the values columns for display 600 subsequent to the pointer up action. The act 375 uses the first key in the three-key sort to place all selected values columns at the left in the property stack. The act 375 uses the second key in the hierarchy to place value bars in decreasing order from left to right. The act 375 uses the third key in the hierarchy to place value bars according to the positions of rows in the property stack from top to bottom.

The act 375 displays the sorted values columns in the composite display wherein all selected values columns are displayed in a darkened color. According to the three-key sort, all selected values columns are at the left of the property stack.

Hereinafter, the term column sort without reference to key number refers to a three-key column sort.

In an embodiment, the act 375 the act 375 uses the white color to display the marker 720 of a selected owner.

In an embodiment for display 700, an act 335 displays statistics about selected owners in the upper status bar. In exemplary status bar 730, the statistics include the information that the pointer down, pointer drag, and pointer up actions selected 49 selected owners out of the total of 417 owners.

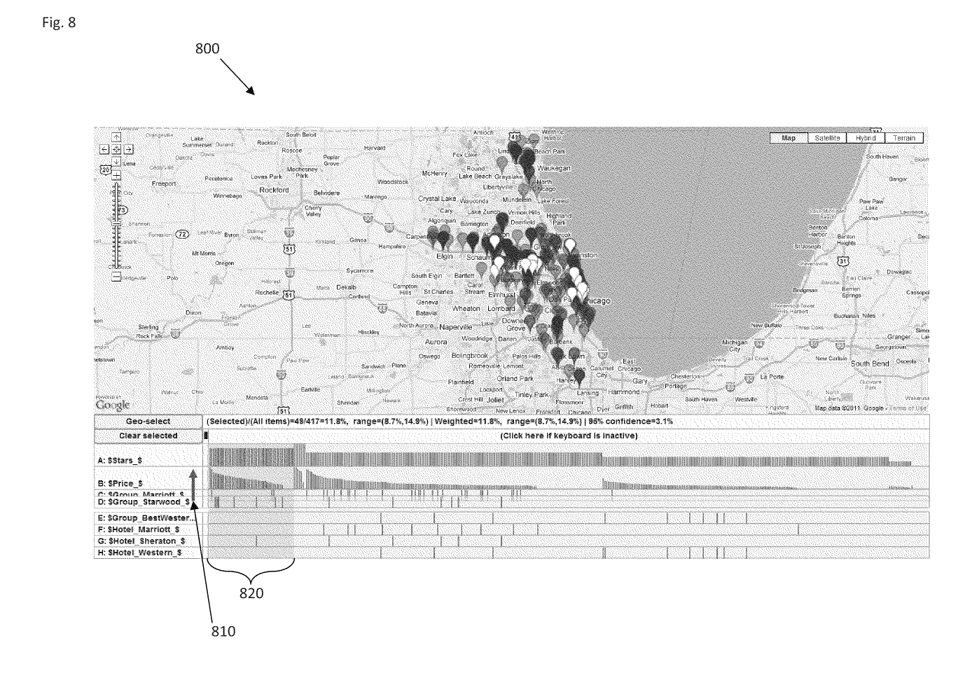

FIG. 8 is a display diagram of a composite display 700 derived from display 600.

For display 800, an act reordering 330 modifies display 600 by reordering property rows. The act 330 replaces a target property row with a replacement property row and moves the target row and all intervening property rows toward the original position of the replacement row in the property stack.

For display 800, an act 330 displays property row D as an exemplary replacement row. For display 800, a user places a pointer down at the tail of the red arrow 810 in the name rectangle of row D and drags row D upward. The act 330 responds by displaying row D as it moves upward in response to the dragging action.

The user performs a pointer up action after dragging replacement row D to the head of the red arrow 810 in row B as an exemplary target row.

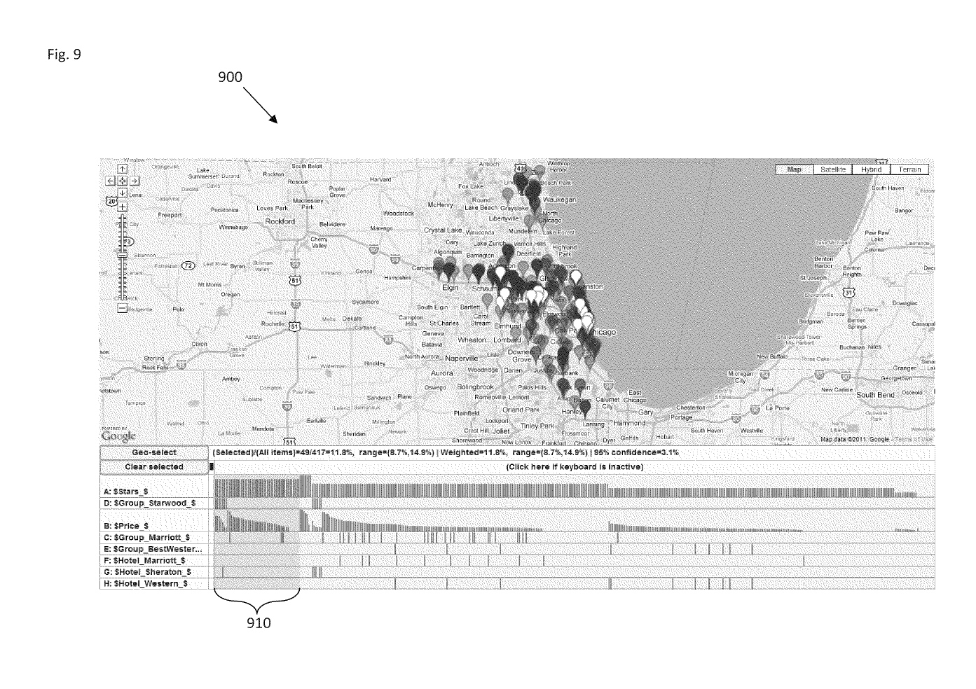

FIG. 9 is a display diagram of a composite display 900 derived from display 800 subsequent to the act 330 responding to the pointer up action of display 800.

For display 900, the act 330 responds to the pointer up action by replacing the target row B with replacement row D and moving the target row B and intervening row C toward the original position of replacement row D. After the movement, the row order of A,B,C,D,E,F,G,H in display 800 is reordered to A,D,B,C,E,F,G,H in display 900.

After the row reordering, the act 330 performs a column sort and displays the sorted values columns in the composite display.

After the column sort, all values in the top row A have the same value of 4 stars in the selected column region 910 and all values columns with value 1 in the second row D are positioned in the left portion of the region. Prior to the reordering and column sorting, the same columns in selected column region 820 for display 800 are not all adjacent to each other in row D.

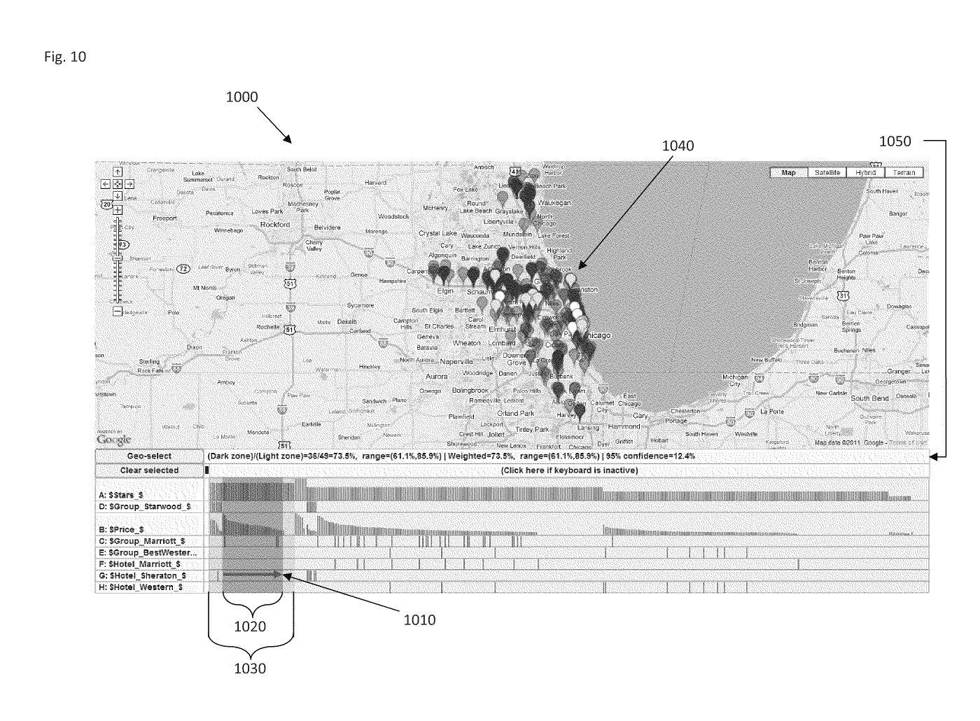

FIG. 10 is a display diagram of a composite display 1000 derived from display 900.

For display 1000, the user modifies display 900 by placing a pointer down at the tail of the red arrow 1010 within region 1030 and dragging the pointer to the right in the direction of the head of the red arrow within the region 1030, and performing a pointer up action at the head of the red arrow.

Subsequent to the pointer up action, an act 380 uses a further-darkened color to display a sub-selected column region wherein the sub-selected region 1020 lies entirely within the selected column region 1030. In an embodiment, an owner with a values column in the sub-selected region is a sub-selected owner.

In an embodiment, the act 380 uses the yellow color to display an exemplary geospatial marker 1040 if the owner is a sub-selected owner.

In an embodiment, the act 380 displays statistics about sub-selected owners in the upper status bar. In exemplary status bar 1020, the statistics include the information that there are 36 sub-selected owners among the 49 selected owners.

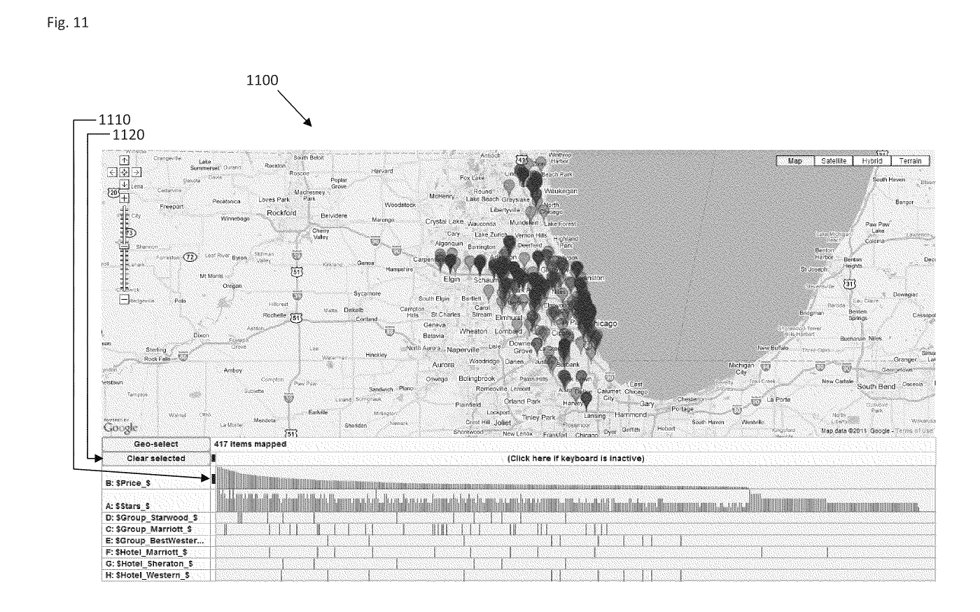

FIG. 11 is a display diagram of a composite display 1100 derived from display 1000.

For display 1100, a user modifies display 1000 by clicking the lower button 1120 marked “Clear selected.” An act clearing 382 responds by deselecting selected owners, by deselecting sub-selected owners, and by resetting the row order to the original row order A,B,C,D,E,F,G,H.

For display 1100, a user drags row B to replace row A. An act reordering 360 responds by reordering the row order from A,B,C,D,E,F,G,H to B,A,C,D,F,G,H, performing a column sort displaying the sorted values columns in the composite display.

For display 1100, an act 350 displays a vertical black bar in the reassigning rectangle of a property row in response to pointer actions performed by a user.

For display 1100, a user places a pointer in the reassigning rectangle of row B at the position of the top of the vertical black bar and drags the pointer vertically downward toward the bottom of the bar. An act 350 displays the exemplary black bar 1110 in row B during the dragging. At the bottom of the black bar, the user performs a pointer up action.

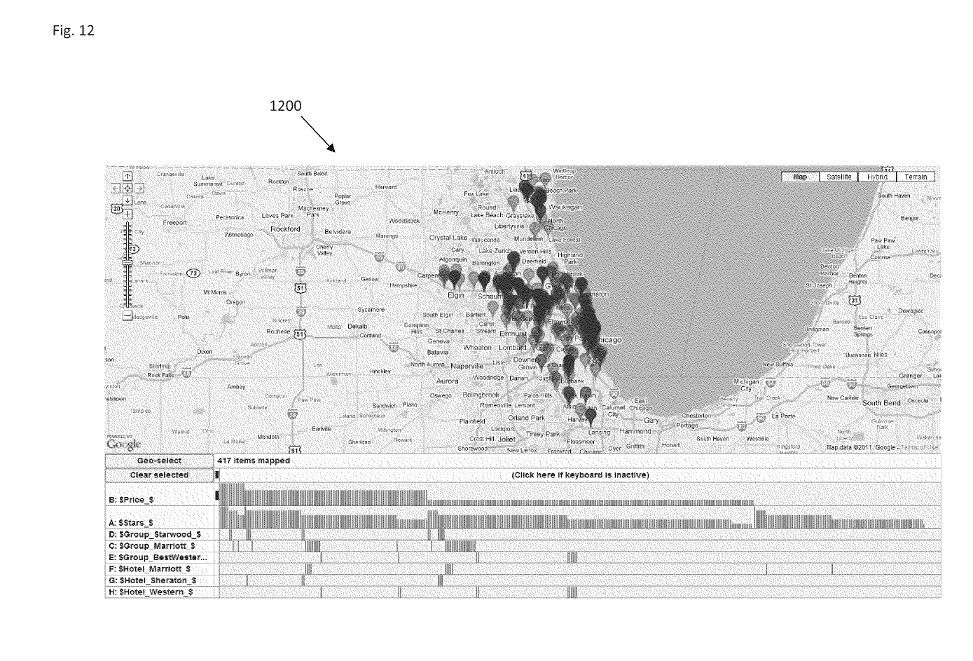

FIG. 12 is a display diagram of a composite display 1200 derived from display 1200 subsequent to the act 350 displaying the exemplary black bar 1110 of display 1000.

For display 1200, the act 350 responds to the pointer up action in row B of display 1100 by reassigning value bar heights in row B. The act 350 reassigns the height of every bar to the full height for row B if the height is greater than the top of the black bar. The act 350 reassigns the height of every remaining value bar to the top of the black bar if the remaining bar has a height greater than the bottom of the black bar. The act 350 reassigns the height of every remaining value bar to the bottom of the black bar if the bar has a height greater than 0. The act 350 performs a column sort and displays the sorted values columns in the composite display.

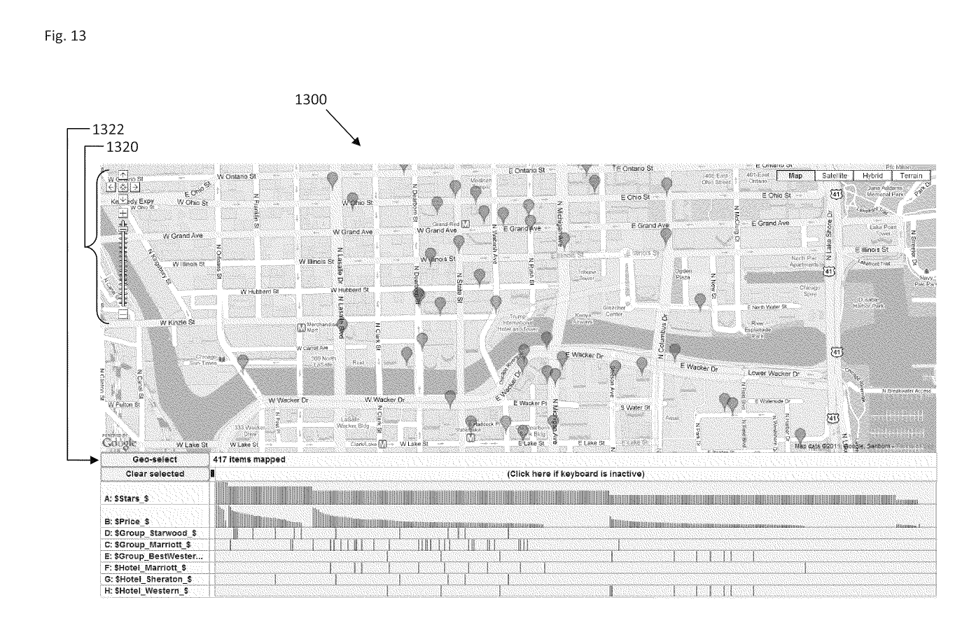

FIG. 13 is a display diagram of a composite display 1300 derived from display 1200.

For display 1300, a user modifies display 1200 by clicking the lower button marked “Clear selected.” An act clearing 382 responds by deselecting selected owners, by deselecting sub-selected owners, and by resetting the row order to the original row order A,B,C,D,E,F,G,H.

For display 1300, an act focusing 385 modifies display 1200 by focusing the geospatial map of the composite display in response to a user using a map control 1320. In an embodiment, the user uses a control to zoom the magnification of the map. In an embodiment, the user uses a control to move the geospatial position of the map.

For display 1300, the act 385 displays a focused map after zooming the map to the detail of single streets and positioning the map to downtown Chicago.

Subsequent to display 1300 displaying the focused map, the user clicks button 1322 labeled “Geo-select.”

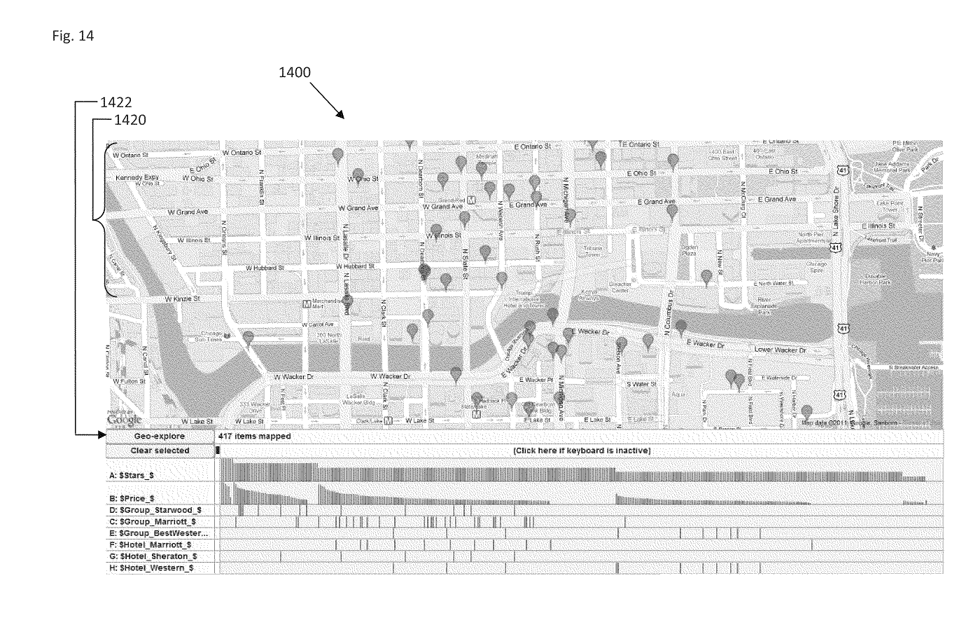

FIG. 14 is a display diagram of a composite display 1400 derived from display 1300 subsequent to an act 385 focusing the geospatial map.

For display 1400, an act toggling 390 responds to the user click of button 1322 for display 1300 by removing map controls 1320, by changing the label of the button from “Geo-select” to “Geo-explore”, and by locking the geospatial map wherein the locking prevents the map from being refocused and allows markers to be selected.

Accordingly, the removal of map controls 1320 for display 1300 by the act 390 results in the absence of the controls 1420 for display 1400. The locking of the geospatial map for display 1300 by the act 390 results in the upper button 1422 being relabeled “Geo-explore.”

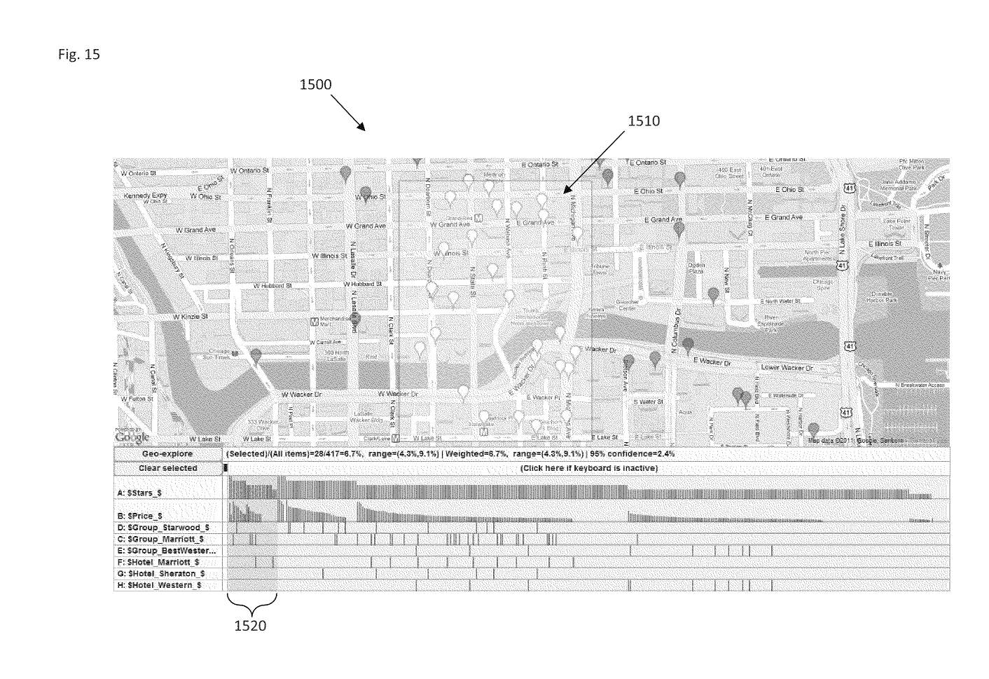

FIG. 15 is a display diagram of a composite display 1500 derived from display 1400 subsequent to a user providing specifications for the locked map.

For display 1500, a user places a pointer down at the northwest corner of a geospatial region and drags the pointer to the southeast corner of the geospatial region wherein the dragged geospatial region has geospatial coordinates between the coordinates of the northwest corner and the coordinates of the dragging position of the pointer. An act 395 responds to the user actions by coloring the dragged geospatial region with a light color.

Subsequent to the dragging action, the user performs a pointer up action. The act 395 responds to the pointer up operation by assigning owners with markers in the dragged region as selected owners. The act 395 uses the white color to display the exemplary marker 1510 of a selected owner. The act 395 performs a column sort and displays the sorted values columns in the composite display including the displaying of the selected columns 1520 in the selected column region in the darkened color.

In an embodiment, a user clicks the lower button labeled “Geo-explore” to restore map controls and to unlock the geospatial map to allow a user to highlight owners by hovering a pointer over a marker on the geospatial map.

Various modifications can be made to the embodiments already described without departing from the scope of the invention discussed herein. These embodiments, among others, include:

(A) Included graphical displays. In some of the embodiments already described, a composite display displays property values of an owner in a property stack and in a supplemental display wherein the supplemental display is a geospatial map. In an embodiment, the supplemental display is a network map including a representation of an owner by a node and links between nodes as edges. In an embodiment, the supplemental display is in three-dimensions. In an embodiment, the supplemental display includes a graphical element representing property values of a plurality of owners. In an embodiment, the graphical element is a wedge in a pie chart wherein the wedge represents property values of a plurality of owners.

In an embodiment, a user highlights an owner by hovering a cursor over a property value of the owner in the supplemental display. In an embodiment, a user selects one or more owners by using pointer actions to select one or more property values of the owners in the supplemental display.

(B) Number of included graphical elements. In some of the embodiments already described, a composite display includes a property stack and a supplemental display. In an embodiment, the composite display includes a property stack and no supplemental graphical displays. In an embodiment, the composite display includes more than one supplemental graphical display.

(C) Construction of ordered sequences of values columns. In some of the embodiments already described, values columns are ordered in a linear sequence using a hierarchical sort. In an embodiment, the linear sequence can be generated using an alternate system. In an embodiment, the system generates the linear sequence using a method of cluster analysis. In another embodiment, the system generates the linear sequence using a solution to the traveling salesman problem.

(D) Display of summaries for owners. In an embodiment, a tooltip replaces a status bar.

(E) User input. In an embodiment, a user enters input using an input device that is not a pointer. In an embodiment, the input device is a keyboard.

(F) Alternate displays of property stacks. In the embodiments already discussed, a property stack has the form of a rectangle. In an alternate embodiment, the rectangle can be rotated. In an alternate embodiment, the rectangle can be bent to have the form of bands which follow a nonlinear shape such as a circle or a snake.

(G) Alternate use of color. In various embodiments already described, property bars are a single color (e.g., blue). In an alternate embodiment, the single color is replaced by a plurality of colors wherein each color represents a different trait of an individual.

(H) Alternative markers. In the embodiments already described, all unselected and un-highlighted makers on the geospatial map are a single color (e.g. blue). In an embodiment, the blue color is replaced by a plurality of colors wherein each color represents a different trait of an individual. In the embodiments already described, makers on the geospatial map are of one shape. In an embodiment, markers on the geospatial map are in a plurality of shapes wherein each color represents a different trait of an individual.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output as described herein. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

In an example embodiment machine is in the example form of a computer system within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system may include a processor (e.g., a central processing unit (CPU), a graphics processing unit (GPU) or both), a main memory and a static memory, which communicate with each other via a bus. The computer system may further include a video display unit (e.g., a liquid crystal display (LCD) or a cathode ray tube (CRT)). The computer system may also include an alphanumeric input device (e.g., a keyboard), a user interface (UI) navigation device (e.g., a mouse), a disk drive unit, a signal generation device (e.g., a speaker) and a network interface device.

The disk drive unit 316 may include a machine-readable medium on which is stored one or more sets of instructions and data structures (e.g., software) embodying or utilized by any one or more of the methodologies or functions described herein. The instructions may also reside, completely or at least partially, within the main memory and/or within the processor during execution thereof by the computer system, the main memory and the processor also constituting machine-readable media.

While the machine-readable medium is discussed in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions may further be transmitted or received over a communications network using a transmission medium. The instructions may be transmitted using the network interface device and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
accessing data representing a population of individuals, wherein each individual in the population is associated with a plurality of properties having values;
constructing and displaying a property stack including:
at least one property row, wherein each property row includes a series of value bars corresponding to one of the plurality of properties and wherein a value bar represents a value of the property associated with an individual in the population; and
a plurality of value columns, wherein a value column includes a plurality of value bars associated with an individual and wherein the value bars are aligned in a column;
sorting the series of value bars within the at least one property row;
receiving user input specification for a manipulation of a portion of the property stack; and
in response to the user input, updating the property stack.

2. The method of claim 1, further comprising:
displaying a map including indicia representing the individuals in the population.

3. The method of claim 2, further comprising:
receiving a user selection of a region of the map; and
highlighting value columns in the property stack associated with the individuals represented by indicia in the region.

4. The method of claim 2, wherein the user input specification is hovering over a value column and wherein indicia representing an individual associated with the value column is highlighted on the map.

5. The method of claim 1, wherein sorting the series of value bars comprises sorting the value bars within a property row according to heights of the value bars within the property row.

6. The method of claim 1, wherein the user input specification is for rearranging the order of the at least one property row in the property stack and wherein updating the property stack includes resorting the series of value bars within the at least one property row.

7. The method of claim 1, wherein sorting the series of value bars within the at least one property row comprises:
sorting the plurality of value columns according to a property of a top property row within the property stack.

8. A computer-readable medium comprising instructions, which when executed by a processor cause the process to:
access data representing a population of individuals, wherein each individual in the population is associated with a plurality of properties having values;
construct and display a property stack including:
at least one property row, wherein each property row includes a series of value bars corresponding to one of the plurality of properties and wherein a value bar represents a value of the property associated with an individual in the population; and
a plurality of value columns, wherein a value column includes a plurality of value bars associated with an individual and wherein the value bars are aligned in a column;
sort the series of value bars within the at least one property row;
receive user input specification for a manipulation of a portion of the property stack; and
in response to the user input, update the property stack.

9. The computer-readable medium of claim 8, further comprising instructions to cause the processor to:
display a map including indicia representing the individuals in the population.

10. The computer-readable medium of claim 9, further comprising instructions to cause the processor to:
receive a user selection of a region of the map; and
highlight value columns in the property stack associated with the individuals represented by indicia in the region.

11. The computer-readable medium of claim 9, wherein the user input specification is hovering over a value column and wherein indicia representing an individual associated with the value column is highlighted on the map.

12. The computer-readable medium of claim 8, wherein the instruction which cause the process to sort the series of value bars comprises instructions to sort the value bars within a property row according to heights of the value bars within the property row.

13. The computer-readable medium of claim 8, wherein the user input specification is for rearranging the order of the at least one property row in the property stack and wherein updating the property stack includes resorting the series of value bars within the at least one property row.

14. The computer-readable medium of claim 8, wherein the instructions which cause the processor to sort the series of value bars within the at least one property row comprise instructions to:
sort the plurality of value columns according to a property of a top property row within the property stack.

15. A system comprising:
an entering logic to access data representing a population of individuals, wherein each individual in the population is associated with a plurality of properties having values;
an analyzing logic to construct a property stack including:
at least one property row, wherein each property row includes a series of value bars corresponding to one of the plurality of properties and wherein a value bar represents a value of the property associated with an individual in the population; and
a plurality of value columns, wherein a value column includes a plurality of value bars associated with an individual and wherein the value bars are aligned in a column;
the analyzing logic to sort the series of value bars within the at least one property row;
and inputting logic to receive user input specification for a manipulation of a portion of the property stack; and
and outputting logic to update the property stack in response to the user input.

16. The system of claim 15, wherein the outputting logic is to display a map including indicia representing the individuals in the population.

17. The system of claim 16, wherein the inputting logic is to receive a user selection of a region of the map; and highlight value columns in the property stack associated with the individuals represented by indicia in the region.

18. The system of claim 16, wherein the user input specification is hovering over a value column and wherein indicia representing an individual associated with the value column is highlighted on the map.

19. The system of claim 15, wherein the analyzing logic is to sort the value bars within a property row according to heights of the value bars within the property row.

20. The system of claim 15, wherein the user input specification is for rearranging the order of the at least one property row in the property stack and wherein updating the property stack includes resorting the series of value bars within the at least one property row.

21. The system of claim 15, wherein the analyzing logic is to:
sort the plurality of value columns according to a property of a top property row within the property stack.
